(19) United States
(12) Patent Application Publication
(10) Pub. No.: US 2026/0167199 A1
(43) Pub. Date: Jun. 18, 2026

(54) VEHICLE WHEEL CONTROL SYSTEM, WHEEL CONTROLLER OF VEHICLE AND VEHICLE HAVING THE SAME

(71) Applicants: Hyundai Motor Company, Seoul (KR); Kia Corporation, Seoul (KR)

(72) Inventor: Soo Hyuk LEE, Hwaseong-si (KR)

(73) Assignees: Hyundai Motor Company, Seoul (KR); Kia Corporation, Seoul (KR)

(21) Appl. No.: 19/219,545

(22) Filed: May 27, 2025

(30) Foreign Application Priority Data
Dec. 18, 2024 (KR) 10-2024-0190091

(51) Int. Cl. B60W 30/18; B60W 10/08; B60W 10/184

(52) U.S. Cl. CPC B60W 30/18172; B60W 10/08; B60W 10/184; B60W 2520/28; B60W 2756/00

(57) ABSTRACT

A vehicle wheel control system, a wheel controller of a vehicle, and a vehicle including the same are provided. The vehicle wheel control system includes a plurality of wheel speed sensors configured to measure a speed of wheels of a vehicle, a plurality of local controllers installed on the wheels of the vehicle and controlling the wheels of the vehicle, a central controller connected to the plurality of local controllers, and a dual local bus line connected between the plurality of local controllers and the central controller and configured to transmit and receive data.

### CROSS-REFERENCE TO RELATED APPLICATION(S)

This application claims benefit of priority to Korean Patent Application No. 10-2024-0190091 filed on Dec. 18, 2024 in the Korean Intellectual Property Office, the disclosure of which is incorporated herein by reference in its entirety.

### BACKGROUND

### 1. Field

The present disclosure relates to a vehicle wheel control system, a wheel controller of a vehicle, and a vehicle including the same.

### 2. Description of Related Art

To improve the stability of vehicle operation, an anti-lock brake system (ABS) is applied to the vehicle. A vehicle with an ABS is equipped with a wheel speed sensor, on the wheel bearing or wheel, measuring a rotation speed of each wheel. The wheel speed sensor may calculate a rotation speed of each wheel by detecting the rotation of a pulse ring having a groove or protrusion formed on the surface.

The vehicle according to the related art may have a structure in which the wheel speed sensor installed on each wheel is connected to the central controller through hard wiring.

As illustrated in FIG. 1, a vehicle 10 includes a plurality of wheel speed sensors 130a, 130b, 130c and 130d mounted on a plurality of wheels 11a, 11b, 11c and 11d. Measurement values by the plurality of wheel speed sensors 130a, 130b, 130c and 130d are transmitted to a central controller 110 through hard wires 12a, 12b, 12c and 12d. The hard wires 12a, 12b, 12c and 12d typically include power lines and signal lines.

According to the related art technology, as the length of the hard wires 12a, 12b, 12c and 12d increases and the internal structure of the vehicle 10 becomes more complex, there may be a problem that it may be difficult to control the vehicle normally when a fault such as a short circuit or open circuit occurred in a part of the hard wires 12a, 12b, 12c and 12d.

### SUMMARY

An aspect of the present disclosure is to provide a vehicle wheel control system, a wheel controller of a vehicle, and a vehicle including the same, which may secure system redundancy through a dual bus line between a local Electronic Control Unit (ECU) and a central ECU, secure additional redundancy through a WSO line, a separate hard wire from a bus line, and implement a smart actuator.

An aspect of the present disclosure is to provide a vehicle wheel control system, a wheel controller of a vehicle, and a vehicle including the same, in which the length and number of physical wirings connected to a wheel speed sensor may be reduced.

Therefore, according to an aspect of the present disclosure, a vehicle wheel control system, a wheel controller of a vehicle, and a vehicle including the same may be provided.

According to an aspect of the present disclosure, a vehicle wheel control system includes a plurality of wheel speed sensors configured to measure a speed of wheels of a vehicle, a plurality of local controllers installed on the wheels of the vehicle and controlling the wheels of the vehicle, a central controller connected to the plurality of local controllers, and a dual local bus line connected between the plurality of local controllers and the central controller and transmitting and receiving data.

According to an aspect of the present disclosure, a wheel controller of a vehicle includes a wheel sensor communication unit receiving a measurement value through a wheel sensor line connected to a wheel speed sensor installed on a wheel of a vehicle, a signal processing unit deriving wheel speed data based on the measurement value of the wheel speed sensor, a central communication unit transmitting and receiving data through a dual local bus line connected to a central controller of the vehicle, and a wheel control unit controlling driving and braking of the wheel.

According to an aspect of the present disclosure, a vehicle includes a plurality of wheels including a motor and an electronic brake, a plurality of wheel speed sensors installed on the plurality of wheels and measuring speeds of the plurality of wheels, a plurality of local controllers provided to respectively correspond to the plurality of wheels and controlling the plurality of wheels, a central controller connected to the plurality of local controllers, and a dual local bus line connected between the plurality of local controllers and the central controller and transmitting and receiving data.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 illustrates a connection structure of a wheel speed sensor and a central controller of the related art;

FIG. 2 is a block diagram of a vehicle including a vehicle wheel control system according to an embodiment of the present disclosure;

FIG. 3 schematically illustrates a part of a configuration of a vehicle including a vehicle wheel control system according to an embodiment;

FIG. 4 is a block diagram of a wheel controller of a vehicle according to an embodiment; and

FIG. 5 is a block diagram of a computing device that may fully or partially implement a vehicle wheel control system according to an embodiment.

### DETAILED DESCRIPTION

Hereinafter, detailed embodiments will be described with reference to the drawings. The following detailed description is provided to help a comprehensive understanding of the methods, devices, and/or systems described in this specification. However, this is merely an example and the present disclosure is not limited thereto.

In describing embodiments, if it is determined that a detailed description of known technologies related to the present disclosure may unnecessarily obscure the gist of the present disclosure, the detailed description thereof will be omitted. In addition, the terms described below are terms defined in consideration of their functions in the present disclosure and may vary depending on the intention or custom of the user or operator, or the like. Therefore, the definitions should be made based on the contents throughout this specification. The terms used in the detailed description are only for the purpose of describing embodiments and should not be limited. Unless clearly used otherwise, expressions in the singular form include plural meanings. In this description, expressions such as “including”, “having” and “provided” are intended to refer to certain features, numbers, steps, operations, elements, parts or combinations thereof, and should not be construed to exclude the presence or possibility of one or more other features, numbers, steps, operations, elements, parts or combinations thereof other than those described.

In addition, throughout the specification, when a part is said to be “connected” to another part, this includes not only cases where it is “directly connected” but also cases where it is “indirectly connected” with other elements therebetween.

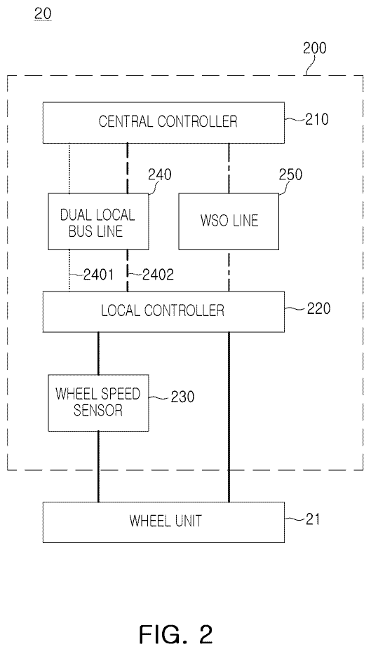

FIG. 2 schematically illustrates a vehicle including a vehicle wheel control system according to an embodiment. Referring to FIG. 2, a vehicle 20 may include a wheel unit 21 and a vehicle wheel control system 200.

The wheel unit 21 may include an axle connecting member and a wheel mechanism for driving the vehicle 20. The vehicle 20 may include four wheel units including, for example, a left front wheel, a right front wheel, a left rear wheel, and a right rear wheel.

In an embodiment, the wheel unit 21 may include a motor and an electronic brake. Driving and braking of the vehicle 20 may be controlled by controlling at least one of the motor and the electronic brake of the wheel unit 21.

The vehicle wheel control system 200 may include a central controller 210, a plurality of local controllers 220, a plurality of wheel speed sensors 230, and a dual local bus line 240.

The central controller 210 may receive information about the state of the vehicle 20 or the driving situation of the vehicle 20 from other components of the vehicle 20, and derive a command to control the vehicle 20. For example, the central controller 210 may receive wheel speed data of the vehicle 20 from the local controller 220.

The local controller 220 may be installed on the wheel of the vehicle 20 and control the wheel of the vehicle 20. For example, the local controller 220 may control the wheel of the vehicle 20 based on the control command of the central controller 210.

The local controller 220 may control the driving and braking of the wheel of the vehicle 20. The local controller 220 may include a wheel drive control unit that controls the driving of the wheel of the vehicle 20, and a wheel braking control unit that controls the braking of the wheel of the vehicle 20.

The wheel speed sensor 230 is installed on the wheel of the vehicle 20 and may measure the speed of the wheel of the vehicle 20. The wheel speed sensor 230 may be installed on the inside of the wheel of the vehicle 20. The wheel speed sensor 230 may detect the wheel speed by detecting, for example, a change in a magnetic field generated according to the rotation of the wheel of the vehicle 20.

The wheel speed sensor 230 may be connected to a local controller 220 installed on the same wheel. A power line and a signal line may be connected between the wheel speed sensor 230 and the local controller 220.

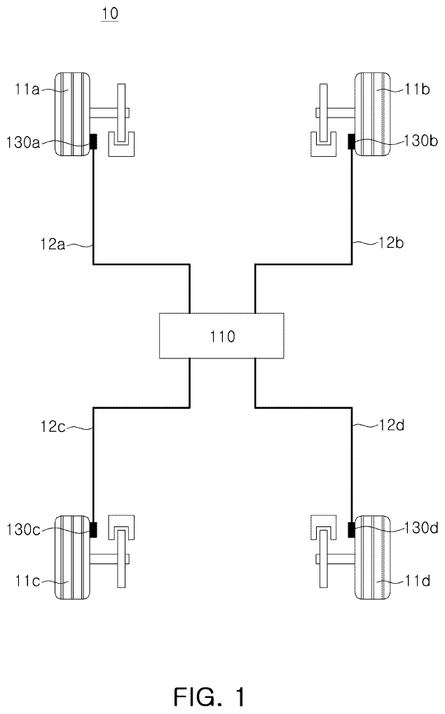

The wiring connecting the wheel speed sensor 230 and the local controller 220 may be shorter than the wiring according to the related art illustrated in FIG. 1.

The local controller 220 may receive the measurement value of the wheel speed sensor from the wheel speed sensor 230 connected thereto. In this case, the measurement value of the wheel speed sensor may be analog data.

The local controller 220 may derive wheel speed data based on the received measurement value of the wheel speed sensor. In this case, the wheel speed data may be digital data derived based on the measurement value of the wheel speed sensor.

The dual local bus line 240 may include a network connected between the local controller 220 and the central controller 210.

The dual local bus line 240 may transmit and receive data between the local controller 220 and the central controller 210. The local controller 220 and the central controller 210 may transmit and receive data, for example, through CAN communication.

The dual local bus line 240 may include a first local bus line 2401 and a second local bus line 2402. The vehicle wheel control system according to the present disclosure may secure redundancy by including the dual local bus line 240.

The first local bus line 2401 and the second local bus line 2402 may include a network connected between the local controller 220 and the central controller 210. The first local bus line 2401 and the second local bus line 2402 may include different paths.

The local controller 220 may transmit wheel speed data to the central controller 210 using at least one of the first local bus line 2401 and the second local bus line 2402.

The central controller 210 may include a first processing unit and a second processing unit. The first processing unit may process data transmitted via the first local bus line 2401. The second processing unit may process data transmitted via the second local bus line 2402.

The central controller 210 may derive vehicle speed data and wheel slip rate data based on wheel speed data transmitted from the local controller 220. The central controller 210 may derive vehicle speed data and wheel slip rate data based on wheel speed data transmitted from, for example, four wheels.

The central controller 210 may derive a control command for the wheel of the vehicle based on the vehicle speed data and the wheel slip rate data. The control command for the wheel of the vehicle may include, for example, target slip rate information or target clamping force size information.

The vehicle wheel control system 200 according to the present disclosure may secure redundancy of vehicle control by including a dual local bus line 240, and may improve the safety and reliability of the vehicle.

For example, the vehicle wheel control system 200 may implement an Electro-Mechanical Brake (EMB) function based on data transmitted and received through one of the first local bus line 2401 and the second local bus line 2402, and may verify the stability and reliability of communication of one of the bus lines by using the other of the first local bus line 2401 and the second local bus line 2402.

In addition, the vehicle wheel control system 200 may continuously implement the EMB function by using the remaining bus line even when one of the first local bus line 2401 and the second local bus line 2402 is broken or an error occurs.

The vehicle wheel control system 200 may further include a Wheel Speed Out (WSO) line 250.

The WSO line 250 may include wiring connected between the local controller 220 and the central controller 210. The WSO line 250 may transmit the measurement value of the wheel speed sensor from the local controller 220 to the central controller 210.

The central controller 210 may receive the measurement value of the wheel speed sensor through the WSO line 250 when data transmission using at least one of the first local bus line 2401 and the second local bus line 2402 fails.

The central controller 210 may derive vehicle speed data and wheel slip rate data based on the measurement value of the wheel speed sensor.

The vehicle wheel control system 200 may secure additional redundancy by including the WSO line 250.

For example, the vehicle wheel control system 200 may receive the measurement value of the wheel speed sensor through the WSO line 250 to the central controller 210 even when data transmission and reception through the dual local bus line 240 is impossible. The central controller 210 may estimate wheel speed data based on the measurement value of the wheel speed sensor and derive vehicle speed data and wheel slip rate data to implement an emergency braking function.

The present disclosure may more reliably ensure the braking stability of the vehicle by implementing the emergency braking function through the WSO line 250 in a situation where the dual local bus line 240 does not operate normally.

The vehicle 20 may further include one or more sensors. One or more sensors are installed inside or outside the vehicle 20 and may detect information related to the state of the vehicle 20 or the driving situation of the vehicle 20.

The one or more sensors may include at least one of, for example, a vehicle speed sensor that detects a driving speed of the vehicle 20, an accelerator pedal position sensor (APS) that is linked to the operation of an accelerator pedal, a brake pedal sensor (BPS) that is linked to the operation of a brake pedal, a steering angle sensor (SAS) that is linked to the operation of a steering wheel, a temperature sensor that detects a temperature inside or outside the vehicle 10, an image sensor that obtains image data inside or outside the vehicle 20, and a distance sensor that measures a distance from the vehicle 20 to an obstacle located in one direction.

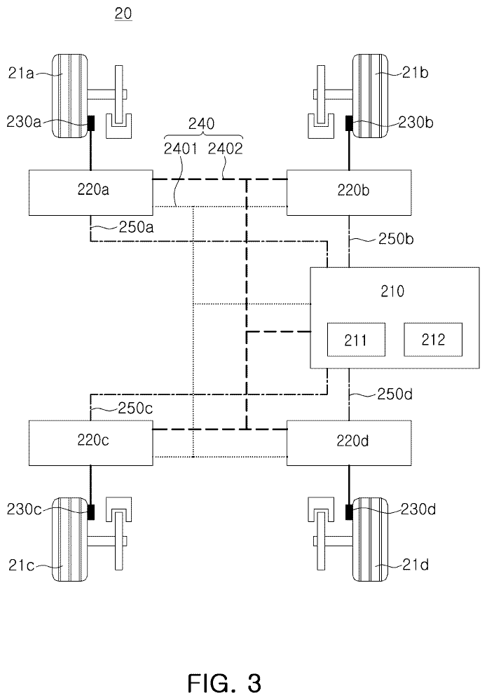

FIG. 3 schematically illustrates a vehicle including a vehicle wheel control system according to an embodiment.

As illustrated in FIG. 3, the vehicle 20 may include a plurality of wheel units 21a, 21b, 21c and 21d, a central controller 210, a plurality of local controllers 220a, 220b, 220c and 220d, a plurality of wheel speed sensors 230a, 230b, 230c and 230d, a dual local bus line 240, and a plurality of WSO lines 250a, 250b, 250c and 250d.

A plurality of local controllers 220a, 220b, 220c and 220d may be provided to respectively correspond to the plurality of wheel units 21a, 21b, 21c and 21d. A plurality of local controllers 220a, 220b, 220c and 220d may control a corresponding wheel unit.

A plurality of wheel speed sensors 230a, 230b, 230c and 230d may be provided to respectively correspond to a plurality of wheel units 21a, 21b, 21c and 21d. A plurality of wheel speed sensors 230a, 230b, 230c and 230d may be connected to a local controller installed on the same wheel.

A plurality of local controllers 220a, 220b, 220c and 220d may receive measurement values from the connected wheel speed sensors. A plurality of local controllers 220a, 220b, 220c and 220d may derive wheel speed data based on the received measurement values of the wheel speed sensors. The measurement values of the wheel speed sensors may be analog data, and the wheel speed data may be digital data.

The dual local bus line 240 may include a network connected between a plurality of local controllers 220a, 220b, 220c and 220d and a central controller 210. The dual local bus line 240 may transmit and receive data between the plurality of local controllers 220a, 220b, 220c and 220d and the central controller 210.

The dual local bus line 240 may include a first local bus line 2401 and a second local bus line 2402.

The first local bus line 2401 and the second local bus line 2402 may include a network connected between the plurality of local controllers 220a, 220b, 220c and 220d and the central controller 210. The first local bus line 2401 and the second local bus line 2402 may include different paths.

A plurality of local controllers 220a, 220b, 220c and 220d may transmit wheel speed data to the central controller 210 using at least one of the first local bus line 2401 and the second local bus line 2402.

The central controller 210 may include a first processing unit 211 and a second processing unit 212. The first processing unit 211 may process data transmitted through the first local bus line 2401. The second processing unit 212 may process data transmitted through the second local bus line 2402.

The central controller 210 may derive vehicle speed data and wheel slip rate data based on wheel speed data transmitted from multiple local controllers 220a, 220b, 220c and 220d. The central controller 210 may derive control commands for wheels of the vehicle.

The multiple WSO lines 250a, 250b, 250c and 250d may include wiring connected between the multiple local controllers 220a, 220b, 220c and 220d and the central controller 210. The multiple WSO lines 250a, 250b, 250c and 250d may transmit measurement values of wheel speed sensors from the local controllers connected to the multiple local controllers 220a, 220b, 220c and 220d to the central controller 210.

As illustrated in FIG. 3, multiple WSO lines 250a, 250b, 250c and 250d may connect all of multiple local controllers 220a, 220b, 220c and 220d and the central controller 210.

In another embodiment, the vehicle may be connected to the central controller 210 through some of the multiple local controllers 220a, 220b, 220c and 220d through the WSO lines.

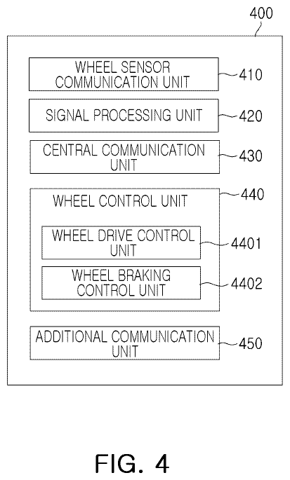

FIG. 4 is a block diagram of a wheel controller of a vehicle according to an embodiment. The wheel controller of a vehicle 400 illustrated in FIG. 4 may be the local controller of FIG. 2 and FIG. 3.

The wheel controller of a vehicle 400 is installed near a wheel of the vehicle and may control the operation of the wheel.

The wheel controller of the vehicle 400 may include a wheel sensor communication unit 410, a signal processing unit 420, a central communication unit 430, a wheel control unit 440, and an additional communication unit 450. The wheel sensor communication unit 410, the signal processing unit 420, the central communication unit 430, the wheel control unit 440, and the additional communication unit 450 of the wheel controller of the vehicle 400 according to an exemplary embodiment of the present disclosure may be a hardware device implemented by various electronic circuits (e.g., computer, microprocessor, CPU, ASIC, circuitry, logic circuits, etc.). The wheel sensor communication unit 410, the signal processing unit 420, the central communication unit 430, the wheel control unit 440, and the additional communication unit 450 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s).

The wheel sensor communication unit 410 may be connected to a wheel speed sensor installed on a wheel of a vehicle through a wheel sensor line. The wheel sensor communication unit 410 may receive a measurement value of the wheel speed sensor.

The signal processing unit 420 may derive wheel speed data based on the measurement value of the wheel speed sensor. The measurement value of the wheel speed sensor may be analog data, and the wheel speed data may be digital data.

The central communication unit 430 may transmit and receive data through a dual local bus line connected to a central controller of a vehicle. The dual local bus line may include a network for transmitting and receiving data.

The dual local bus line may include a first local bus line and a second local bus line having different paths.

The central communication unit 430 may transmit wheel speed data to the central controller of the vehicle using at least one of the first local bus line and the second local bus line.

The central communication unit 430 may receive vehicle speed data and wheel slip rate data from the central controller using at least one of the first local bus line and the second local bus line. The vehicle speed data and the wheel slip rate data may be derived from the central controller of the vehicle based on the wheel speed data.

The central communication unit 430 may receive a control command from the central controller using at least one of the first local bus line and the second local bus line. The control command may be derived from the central controller of the vehicle based on the wheel speed data. The control command may include target driving information or target braking information.

The wheel control unit 440 may control driving and braking of the wheel based on the control command. The wheel control unit 440 may include a wheel drive control unit 4401 and a wheel braking control unit 4402. The wheel drive control unit 4401 and the wheel braking control unit 4402 according to an exemplary embodiment of the present disclosure may be a hardware device implemented by various electronic circuits (e.g., computer, microprocessor, CPU, ASIC, circuitry, logic circuits, etc.). The wheel drive control unit 4401 and the wheel braking control unit 4402 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s).

The wheel drive control unit 4401 may control driving of the wheel based on the control command. The wheel braking control unit 4402 may control the braking of the wheel based on the control command.

The additional communication unit 450 may transmit the measurement value of the wheel speed sensor to the central controller through the WSO line connected to the central controller.

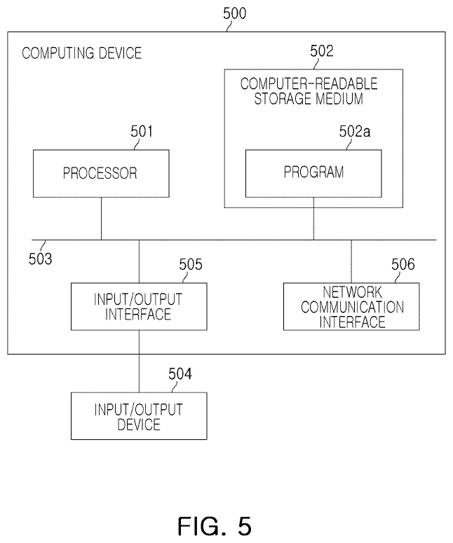

FIG. 5 is a block diagram of a computing device 500 that may fully or partially implement the vehicle wheel control system 200 according to an embodiment, and may implement all or part of the central controller or local controller illustrated in FIGS. 2 and 3.

As illustrated in FIG. 5, the computing device 500 includes at least one processor 501, a computer-readable storage medium 502, and a communication bus 503.

The processor 501 may cause the computing device 500 to operate according to the example embodiments mentioned above. For example, the processor 501 may execute one or more programs stored in the computer-readable storage medium 502. The one or more programs may include one or more computer-executable instructions, and the computer-executable instructions may be configured to cause the computing device 500 to perform operations according to example embodiments when executed by the processor 501.

The computer-readable storage medium 502 is configured to store computer-executable instructions or program code, program data, and/or other suitable forms of information. The program 502a stored on the computer-readable storage medium 502 includes a set of instructions executable by the processor 501. In an embodiment, the computer-readable storage medium 502 may be memory (a volatile memory such as a random access memory, a nonvolatile memory, or a suitable combination thereof), one or more magnetic disk storage devices, optical disk storage devices, flash memory devices, or any other form of storage medium that may be accessed by the computing device 500 and store required information, or suitable combinations thereof.

The communication bus 503 interconnects the processor 501, the computer-readable storage medium 502, and other various components of the computing device 500.

The computing device 500 may also include one or more input/output interfaces 505 that provide interfaces for one or more input/output devices 504, and one or more network communication interfaces 506. The input/output interfaces 505 and the network communication interfaces 506 are connected to the communication bus 503.

The network communication interface 506 may be an interface for communication within the vehicle or for communication between the vehicle and other devices outside the vehicle, and may include, for example, a Controller Area Network (CAN), a Media Oriented Systems Transport (MOST) network, a Local Interconnect Network (LIN) and/or X-by-Wire (Flexray), Wi-Fi, Bluetooth, NFC, RFID, or the like. The network may be a cellular network, such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), or Long Term Evolution (LTE), or one of other cellular networks.

The input/output device 504 may be connected to other components of the computing device 500 via an input/output interface 505. Examples of the input/output device 504 may include input devices such as pointing devices (such as a mouse or trackpad), keyboards, touch input devices (such as a touchpad or touchscreen), voice or sound input devices, various types of sensor devices, and/or photographing devices, and/or output devices such as display devices, printers, speakers, and/or network cards. The example input/output device 504 may be included in the computing device 500 as a component that constitutes the computing device 500, or may be connected to the computing device 500 as a separate device distinct from the computing device 500.

Meanwhile, in an embodiment of the present disclosure, a program for performing the methods described in this specification on a computer, and a computer-readable recording medium including the program may be included. The computer-readable recording medium may include program commands, local data files, local data structures, or the like alone or in combination. The medium may be those designed and configured specifically for the present disclosure, or may be those commonly available in the field of computer software. Examples of the computer-readable recording medium include magnetic media such as hard disks, floppy disks, and magnetic tapes, optical recording media such as CD-ROMs and DVDs, and hardware devices specifically configured to store and execute program commands such as ROMs, RAMs, and flash memories. Examples of the program may include not only machine language codes such as those generated by a compiler, but also high-level language codes that may be executed by a computer using an interpreter, or the like.

As set forth above, according to an embodiment, there may be provided a vehicle wheel control system, a wheel controller of a vehicle, and a vehicle including the same, which may secure system redundancy through a dual bus line between a local Electronic Control Unit (ECU) and a central ECU, secure additional redundancy through a WSO line, a separate hard wire from a bus line, and implement a smart actuator.

According to an embodiment, there may be provided a vehicle wheel control system, a wheel controller of a vehicle, and a vehicle including the same, in which the length and number of physical wirings connected to a wheel speed sensor may be reduced.

While example embodiments have been shown and described above, it will be apparent to those skilled in the art that modifications and variations could be made without departing from the scope of the present disclosure as defined by the appended claims.

What is claimed is:

1. A vehicle wheel control system comprising:
a plurality of wheel speed sensors configured to measure a speed of wheels of a vehicle;
a plurality of local controllers installed on the wheels of the vehicle and controlling the wheels of the vehicle;
a central controller connected to the plurality of local controllers; and
a dual local bus line connected between the plurality of local controllers and the central controller and configured to transmit and receive data.

2. The vehicle wheel control system of claim 1, wherein the plurality of wheel speed sensors are each connected to a local controller installed on the same wheel among the plurality of local controllers, and
the plurality of local controllers receive a measurement value from a wheel speed sensor connected thereto and derive wheel speed data based on the received measurement value.

3. The vehicle wheel control system of claim 2, wherein the plurality of local controllers include,
a wheel drive control unit controlling driving of the wheels of the vehicle; and
a wheel braking control unit controlling braking of the wheels of the vehicle.

4. The vehicle wheel control system of claim 2, wherein the dual local bus line includes:
a first local bus line connected between the plurality of local controllers and the central controller and configured to transmit and receive the data; and
a second local bus line having a path different from a path of the first local bus line, connected between the plurality of local controllers and the central controller, and configured to transmit and receive the data.

5. The vehicle wheel control system of claim 4, wherein the plurality of local controllers transmit the wheel speed data to the central controller using at least one of the first local bus line and the second local bus line.

6. The vehicle wheel control system of claim 5, wherein the central controller derives vehicle speed data and wheel slip rate data based on the wheel speed data transmitted from the plurality of local controllers.

7. The vehicle wheel control system of claim 6, wherein the central controller derives a control command for the wheels of the vehicle based on the vehicle speed data and the wheel slip rate data, and transmits the control command to the plurality of local controllers using at least one of the first local bus line and the second local bus line.

8. The vehicle wheel control system of claim 6, wherein the central controller includes:
a first processing unit processing the data transmitted through the first local bus line; and
a second processing unit processing the data transmitted through the second local bus line.

9. The vehicle wheel control system of claim 4, further comprising a Wheel Speed Out (WSO) line connected between the plurality of local controllers and the central controller and transmitting a measurement value of the wheel speed sensor to the central controller.

10. The vehicle wheel control system of claim 9, wherein the central controller derives vehicle speed data and wheel slip rate data based on the measurement value of the wheel speed sensor transmitted through the WSO line when data transmission using at least one of the first local bus line and the second local bus line fails, and performs emergency braking control based on the vehicle speed data and the wheel slip rate data.

11. A wheel controller of a vehicle, comprising: a wheel sensor communication unit receiving a measurement value through a wheel sensor line connected to a wheel speed sensor installed on a wheel of a vehicle;
a signal processing unit deriving wheel speed data based on the measurement value of the wheel speed sensor;
a central communication unit transmitting and receiving data through a dual local bus line connected to a central controller of the vehicle; and
a wheel control unit controlling driving and braking of the wheel.

12. The wheel controller of claim 11, wherein the wheel control unit includes,
a wheel drive control unit controlling driving of the wheel; and
a wheel braking control unit controlling braking of the wheel.

13. The wheel controller of claim 12, wherein the dual local bus line includes,
a first local bus line connected to the central controller and transmitting and receiving data; and
a second local bus line having a different path from the first local bus line, connected to the central controller, and configured to transmit and receive data.

14. The wheel controller of claim 13, wherein the central communication unit transmits the wheel speed data to the central controller using at least one of the first local bus line and the second local bus line.

15. The wheel controller of claim 14, wherein the central communication unit receives vehicle speed data and wheel slip rate data from the central controller using at least one of the first local bus line and the second local bus line, and
the vehicle speed data and the wheel slip rate data are derived from the central controller based on the wheel speed data.

16. The wheel controller of claim 14, wherein the central communication unit receives a control command from the central controller using at least one of the first local bus line and the second local bus line,
wherein the control command is derived from the central controller based on the wheel speed data.

17. The wheel controller of claim 16, wherein the control command includes target driving information or target braking information, and
the wheel control unit controls driving and braking of the wheel based on the control command.

18. The wheel controller of claim 13, further comprising an additional communication unit transmitting the measurement value of the wheel speed sensor to the central controller through a Wheel Speed Out (WSO) line connected to the central controller when data transmission and reception through the dual local bus line fails.

19. A vehicle comprising:
a plurality of wheels including a motor and an electronic brake;
a plurality of wheel speed sensors installed on the plurality of wheels and measuring speeds of the plurality of wheels;
a plurality of local controllers provided to respectively correspond to the plurality of wheels and controlling the plurality of wheels;
a central controller connected to the plurality of local controllers; and
a dual local bus line connected between the plurality of local controllers and the central controller and configured to transmit and receive data.

20. The vehicle of claim 19, wherein the dual local bus line includes,
a first local bus line connected between the plurality of local controllers and the central controller and transmitting and receiving the data; and
a second local bus line having a different path from the first local bus line, connected between the plurality of local controllers and the central controller, and transmitting and receiving the data.
